(19) United States
(12) Patent Application Publication
(10) Pub. No.: US 2023/0297559 A1
(43) Pub. Date: Sep. 21, 2023

(54) SYSTEM AND METHOD FOR CREATING A USER ACCOUNT FROM A MOBILE STATION

(71) Applicants: Adam RESNICK, Boca Raton, FL (US); Ruslan SABITOV, Jersey City, NJ (US); Michael J. MACKEY, Boca Raton, FL (US)

(72) Inventors: Adam RESNICK, Boca Raton, FL (US); Ruslan SABITOV, Jersey City, NJ (US); Michael J. MACKEY, Boca Raton, FL (US)

(21) Appl. No.: 17/696,244

(22) Filed: Mar. 16, 2022

(51) Int. Cl. G06F 16/23; G06F 16/25

(52) U.S. Cl. CPC G06F 16/2365; G06F 16/252

(57) ABSTRACT

An illustrative example embodiment of a system for registering a user includes at least one computing device that is configured to determine that a user response to a prompt was received from a remote user device. The user response indicates at least two identifiers of the user. The computing device initiates a user account for the user. The computing device determines whether a database includes additional identifiers of the user and associates information with the user account. The information is required for the user account and is based on the two identifiers and any additional identifiers of the user from the database. The computing device causes a request to be sent to the remote user device requesting the user to acknowledge accuracy of the information associated with the user account and to complete creation of the user account.

### BACKGROUND

The number and variety of applications or “apps” for mobile stations or smartphones continuously increases. One issue that hinders some potential users from obtaining an app is the user registration process. It would be useful to app providers to provide an easier or streamlined process that allows new users to sign up for access to an app.

### SUMMARY

An illustrative example embodiment of a system for registering a user includes at least one computing device that is configured to determine that a user response to a prompt was received from a remote user device. The user response indicates at least two identifiers of the user. The computing device initiates a user account for the user. The computing device determines whether a database includes additional identifiers of the user and associates information with the user account. The information, which is required for the user account, is based on the two identifiers and any additional identifiers of the user from the database. The computing device causes a request to be sent to the remote user device requesting the user to review the accuracy of the information associated with the user account and to complete creation of the user account.

The various features and advantages of at least one example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a system for registering a user who desires a product or service.

FIG. 2 is a flow chart diagram summarizing an example embodiment of a method of registering a user.

FIG. 3 schematically illustrates a process of registering a user of one example application.

### DETAILED DESCRIPTION

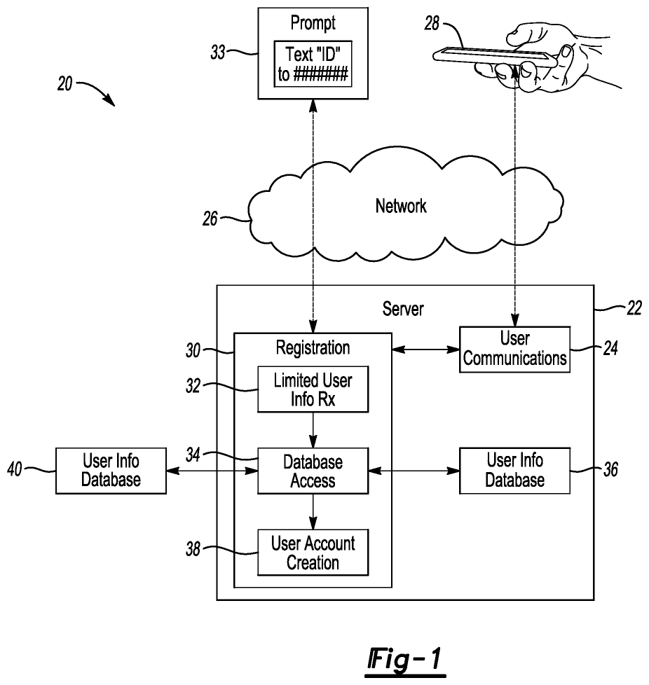

FIG. 1 schematically illustrates a system 20 for streamlining the process of establishing a user account for an individual who desires a product or service. The individual may be purchasing the product or service, obtaining a license to use the product or service, getting access to the product or service, or using the product or service. For discussion purposes, those scenarios are considered equivalent and the following description will refer to acquiring a product or service to generically refer to any of those scenarios. The system 20 and other embodiments include the capability to automatically pre-populate at least some data fields of information required to establish the user account. At least partially filling in such information reduces the barrier to some users acquiring a product or service and improves the user's initial experience with the provider of the product or service.

A server 22 includes at least one computing device having a processor and associated memory. In the illustrated example embodiment, the memory includes a non-transitory storage medium that contains instructions that are executable by the processor to realize the functions of the server 22 included in this description.

FIG. 1 is schematically illustrative in nature and should not be considered limiting. For example, the server 22 is schematically illustrated as if it were a single device but that is not a requirement. The computing device may be part of a single machine or part of separate devices or components. Some embodiments of the system 20 include a plurality of devices that collectively function as the server 22. In some embodiments, at least some of the server 22 is hosted on at least one virtual machine in a cloud computing network.

The server 22 includes a user communication module 24 that facilitates communications over a network 26 with remote user devices 28. The user communication module 24 comprises hardware, firmware, software or a combination of these configured to use known communication protocols. The network 26 includes, for example, the Internet and appropriate communication equipment to allow the server 22 to communicate with the remote user device 28. In some situations, the network 26 is a local area network (LAN) or an ad hoc network. Example remote user devices 28 include mobile stations, such as smartphones and portable computing devices.

The server 22 includes a registration module 30 that comprises hardware, firmware, software or a combination of them. The registration module 30 includes an input module 32 for receiving user information from the remote user device 28. The user information is provided in response to a prompt 33 that is understandable to the user. For example, the prompt 33 may be a display instructing the user to text selected information to a particular number if the user desires to acquire a product or service, such as an application that can be downloaded to and used on the remote user device 28.

The registration module 30 includes a database interface 34 that is configured to access a user information database 36 that is part of the memory of the server 22 or otherwise associated with the server 22. In the illustrated example, the user information database 36 is maintained by the entity that controls the server 22, such as a provider of the product or service that the user desires.

The registration module 30 also includes a user account creator 38 that is configured to initiate a user account when an individual desires to acquire a product or service for which a user account is needed.

The system 20 shown in FIG. 1 includes an external user information database 40 that is maintained by an entity separate from that which controls the server 22. This external database may be hosted, for example, by an entity that maintains an application store. User account information regarding an individual who acquires an application through that store is stored in the database 40. In this example, the database interface 34 may access the user information database 40 under appropriate circumstances.

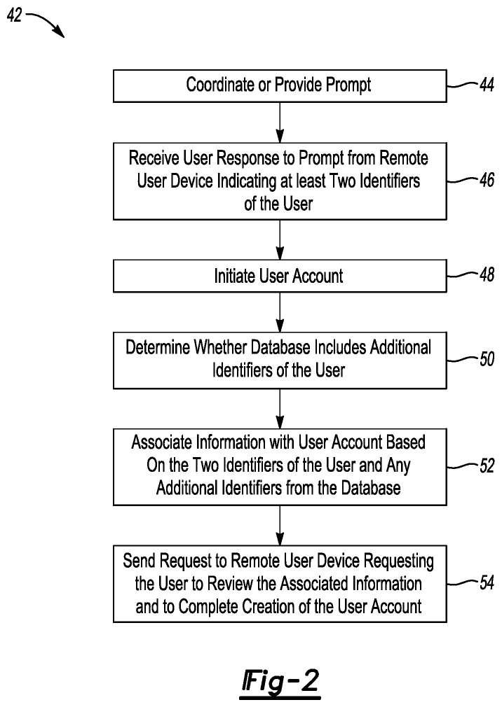

FIG. 2 is a flowchart diagram 42 summarizing an example method of registering a user who desires to acquire a product or service, such as an application that may be downloaded to and accessed on the remote user device 28. The method summarized in FIG. 2 begins at 44 where the prompt 33 is coordinated by the vendor of the product or service or simply provided to the user. Coordinating the prompt may include, for example, making an arrangement with an owner of an establishment where the prompt will be displayed. The prompt may be displayed on an electronic display or on print media, such as a sign. Providing the prompt may involve communicating with a display device or controlling a display device to display the prompt where it can be observed by individuals who will potentially respond to the prompt. In some embodiments, the prompt contains instructions to use a mobile station such as a smart phone to text selected information to a particular number to acquire a particular product or service.

Assuming at least one individual uses a remote user device 28 to respond to the prompt by sending an appropriate text message, at 46, the user communication module 24 of the server 22 receives the user response to the prompt from the remote user device 28. The user response indicates at least two identifiers of the user. The identifiers are unique to the individual user. In an embodiment where the user response is a text message, the phone number or account number of the device from which the text message was sent is one of the at least two identifiers of the user. Other example identifiers include the user's name, birthdate or other identifying information requested through the prompt. In some embodiments, the prompt will instruct the user to send an image, such as a selfie, when sending the text in response to the prompt. In those situations, the image is one of the at least two identifiers of the user. More than two identifiers may be indicated by the user response.

At 48, the registration module 30 initiates a user account for the individual who responded to the prompt 33. The registration module 30 has information regarding the prompt 33, such as an association between the number to which a text message response was sent and the appropriate product or service the individual desires. The input module 32 of the registration module 30 identifies the user information indicated by the received response. At 50, the database interface 34 determines whether the user information database 36 includes any additional identifiers of the user. For example, the entity controlling the server 22 may offer more than one product or service. An individual may have previously created a user account with that entity that is associated with one of those products or services. In such a case, the user information database 36 may contain previously collected information from that individual. The database interface 34 can obtain that information based upon a match between the information indicated in the user response and information stored in the database 36.

At 52, the user account creator 38 associates information with the new user account by including the identifiers that were indicated in the response to the prompt and any additional identifiers that were obtained from the database 36 to include the data needed for corresponding data fields required to create a new user account. The registration module 30 pre-fills the user account information on behalf of the individual who responded to the prompt with as much information as is available to the registration module 30 at that time. In many cases, not all of the required information to establish a user account is available to the user account creator 38. Pre-populating as much as possible of the required information for establishing a new user account at 52 simplifies the user registration process for the individual.

At 54, the server 22 sends a request to the remote user device 28 requesting the user to review the associated information that has been pre-filled into the user account data and to complete creation of the user account. In a situation where all of the required information is already associated with the new user account and the user verifies the accuracy of that information, completing the user account simply requires an acknowledgement from the user. In situations where only some of the required information for establishing the user account has been pre-populated or pre-filled by the registration module 30, completing the user account involves the user providing the remaining required information.

The process summarized in FIG. 2 allows individuals to more readily and more easily establish a user account for acquiring a product or service that requires a user account. The individual can simply text requested information in response to a prompt and then be provided with a pre-populated user account data form that simplifies the process for the individual to acquire the desired product or service.

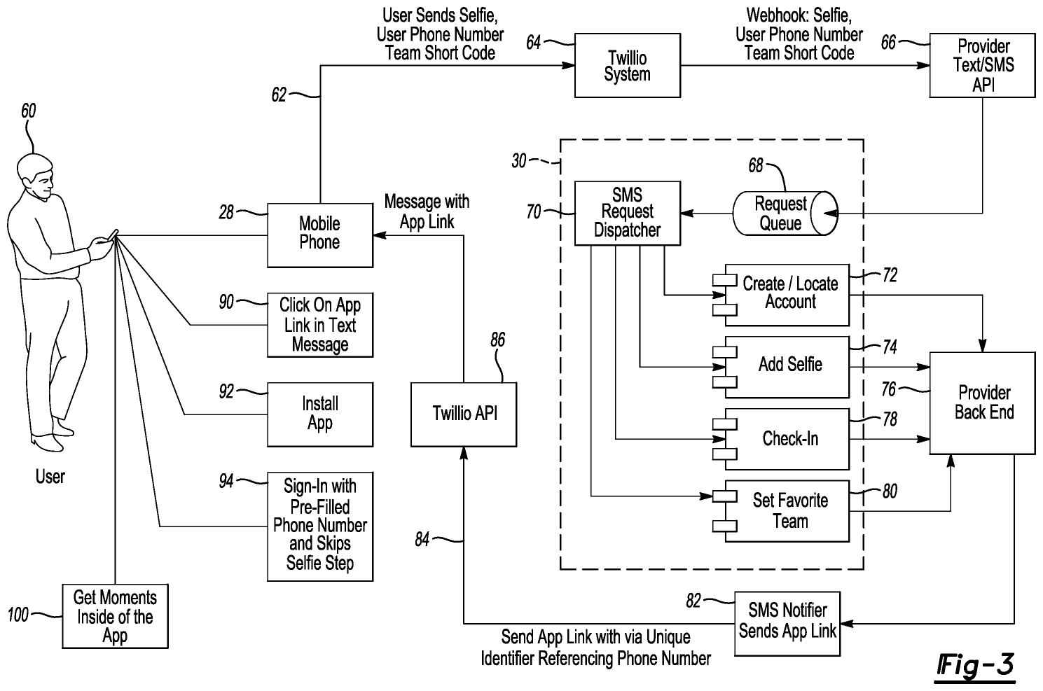

FIG. 3 schematically illustrates one example use of the system 20 applying the method summarized in FIG. 2. In this example, a vendor provides a service through an application that allows individuals to obtain video that includes the individual. For example, an individual attending a sporting event who appears on a visual display screen at the venue hosting the event is able to obtain a copy of the video footage in which the individual appears.

The individual user is represented at 60 in FIG. 3. The user 60 utilizes the remote user device 28, such as a smartphone or another mobile station, to respond to a prompt observed by the user 60. For example, a prompt may appear on the display screen at the venue hosting the sporting event. The prompt directs the user to text information, such as the user's name, a selfie, or both to a particular number. The user sends such a response at 62. In this particular embodiment, the prompt also asks the user to identify which of the teams competing that day is the user's favorite. That information is included in the user response at 62. A communication application programming interface (API) 64 facilitates directing the texted user response at 62 to a text processing API 66 of the vendor or provider. The text API 66 forwards the user request to a request queue 68, which is part of the registration module 30, for example.

A request dispatcher 70 provides the information included in or indicated by the request to the user account creator 38 where the account is created at 72 and the information from the request, such as a selfie image, is added at 74. The provider back end 76, which is part of the server 22 in the embodiment of FIG. 1, processes the information regarding the user account including performing facial recognition processing of the image to establish a record of facial characteristics for purposes of identifying the user in video or still image data so that the user can eventually access such video or images through the application supplied by the vendor.

This example includes a check in process represented at 78. The check in process is used in a situation where the prompt is provided at an event that the user is attending. The check in process includes comparing the facial recognition data associated with the new user account against any video or still image data from that event to identify any video or images that will be available to that user. In this embodiment, a response to the prompt that includes a selfie or another image of the individual triggers the check in process at 78.

In this example, the user request includes an indication of the user's favorite team, which is pre-populated into the user account information at 80.

Once the user account is pre-populated with as much information as is available to the registration module 30, a text notifier 82 sends an appropriate message through an outgoing texting API 86 to the user's smartphone 28. In this example, the message texted back to the user 60 includes a link that can be selected by the user when viewing the text received at the smartphone 28.

At 90, the user selects the link from the text message. That link directs the processor of the smartphone 28 to a site for downloading the application at 92. At 94, the user is presented with a user account form that is pre-populated with the information received or obtained by the registration module 30. In this example, the user texted name and favorite team information along with a selfie image. If no other information was available from a database, such as the database 36 or 40 shown in FIG. 1, that will be the only pre-populated information in the user's account form. The user is then prompted to add any additional information that may be required and then to acknowledge or submit a request to complete the user account. Once received and the user account is verified by the vendor, the user has full access to the application which has been or can be downloaded to the smartphone 28.

Once properly installed, the application allows the user 60 to obtain video or still image data through the application at 100.

Those skilled in the art who have the benefit of this description will realize how to use the pre-populating features of the disclosed example embodiments to facilitate user registration for their particular situation. Simplifying the user registration process as described above increases user adoption of products and services by streamlining the user registration and user account creation process.

The preceding description is exemplary rather than limiting in nature. Variations and modifications to the disclosed example embodiment and scenarios may become apparent to those skilled in the art that do not necessarily depart from the essence of this invention. The scope of legal protection given to this invention can only be determined by studying the following claims.

We claim:

1. A method, comprising:
receiving, from a remote user device, a user response to a prompt, the user response indicating at least two identifiers of the user;
initiating a user account for the user;
determining whether a database includes additional identifiers of the user;
associating information with the user account, wherein the information is based on the at least two identifiers and any additional identifiers of the user from the database, and the information is required for the user account; and
sending a request to the remote user device requesting the user to review the accuracy of the information associated with the user account and to complete creation of the user account.

2. The method of claim 1, wherein requesting the user to complete creation of the user account includes requesting the user to provide any required information that has not yet been associated with the user account.

3. The method of claim 1, wherein the user account is for access to an application and the method comprises, in response to completion of the creation of the user account, communicating with the remote user device to present the user with an option to access the application on the remote user device.

4. The method of claim 3, wherein the user response to the prompt corresponds to an indication that the user intends to download the application to the remote user device.

5. The method of claim 1, wherein
the remote user device is a mobile station having an associated phone number;
the phone number is one of the at least two identifiers of the user; and
the user response is sent as a text message from the mobile station.

6. The method of claim 5, wherein the at least two identifiers of the user include at least one of a name of the user and an image of the user.

7. The method of claim 5, wherein the prompt comprises an indication of a number to direct the text message to and instructions directing the user to include selected information in or with the text message.

8. The method of claim 5, wherein sending the request to the remote user device comprises sending a text message to the mobile station.

9. The method of claim 1, wherein
the user account is for access to or use of at least one product or service from a provider, and
the database is maintained by the provider.

10. The method of claim 1, wherein
the user account is for access to or use of at least one product or service from a provider, and
the database is maintained by a third party distinct from the provider.

11. A system, comprising:
at least one computing device including at least one processor and memory associated with the at least one processor, the at least one computing device being configured to:
determine that a user responded to a prompt by providing a response indicating at least two identifiers of the user;
initiate a user account for the user;
determine whether a database includes additional identifiers of the user;
associate information with the user account, wherein the information is based on the at least two identifiers and any additional identifiers of the user from the database, and the information is required for the user account; and
cause a request to be sent to the remote user device requesting the user to review the accuracy of the information associated with the user account and to complete creation of the user account.

12. The system of claim 11, wherein requesting the user to complete creation of the user account includes requesting the user to provide any required information that has not yet been associated with the user account.

13. The system of claim 11, wherein the user account is for access to an application and the at least one computing device is configured to, in response to completion of the creation of the user account, cause a communication to be sent to the remote user device to present the user with an option to access the application on the remote user device.

14. The system of claim 13, wherein the user response to the prompt corresponds to an indication that the user intends to download the application to the remote user device.

15. The system of claim 1, wherein
the remote user device is a mobile station having an associated phone number;
the phone number is one of the at least two identifiers of the user; and
the user response is sent as a text message from the mobile station.

16. The system of claim 15, wherein the at least two identifiers of the user include at least one of a name of the user and an image of the user.

17. The system of claim 15, wherein the prompt comprises an indication of a number to direct the text message to and instructions directing the user to include selected information in or with the text message.

18. The system of claim 15, wherein the request to the remote user device comprises a text message to the mobile station.

19. The system of claim 11, wherein
the user account is for access to or use of at least one product or service from a provider, and
the database is maintained by the provider.

20. The system of claim 11, wherein
the user account is for access to or use of at least one product or service from a provider, and
the database is maintained by a third party distinct from the provider.
